(19) United States
(12) Patent Application Publication
(10) Pub. No.: US 2013/0225168 A1
(43) Pub. Date: Aug. 29, 2013

(54) METHOD AND APPARATUS FOR BASE STATION IDENTIFICATION DISCOVERY IN WIRELESS COMMUNICATIONS

(71) Applicant: QUALCOMM Incorporated, (US)

(72) Inventors: Damanjit Singh, San Diego, CA (US); Peerapol Tinnakornsrisuphap, San Diego, CA (US); Andrei Radulescu, San Diego, CA (US); Mehmet Yavuz, San Diego, CA (US)

(73) Assignee: QUALCOMM Incorporated, San Diego, CA (US)

(21) Appl. No.: 13/772,152

(22) Filed: Feb. 20, 2013

Related U.S. Application Data
(60) Provisional application No. 61/603,201, filed on Feb. 24, 2012.

(51) Int. Cl. H04W 8/00

(52) U.S. Cl. CPC H04W 8/005
USPC 455/435.1

(57) ABSTRACT

Systems and methods are provided for facilitating base station identity discovery in a wireless communications system. This may be achieved, for example, by exchanging with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE.

### CLAIM OF PRIORITY UNDER 35 U.S.C. §119

The present application for Patent claims the benefit of U.S. Provisional Application No. 61/603,201, entitled “METHOD AND APPARATUS FOR CELL IDENTIFICATION DISCOVERY IN WIRELESS COMMUNICATIONS” filed Feb. 24, 2012, assigned to the assignee hereof, and expressly incorporated herein by reference.

### FIELD OF DISCLOSURE

This disclosure relates generally to telecommunications, and more particularly to femto cell base station identification and the like.

### BACKGROUND

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

In cellular networks, Macro NodeBs (MNBs) provide connectivity and coverage to a large number of users over a certain geographical area. A macro network deployment is carefully planned, designed and implemented to offer good coverage over the geographical region. Such careful planning, however, cannot fully accommodate channel characteristics such as fading, multipath, shadowing, etc., especially in indoor environments. Indoor users, therefore, often face coverage issues (e.g., call outages or quality degradation) resulting in poor user experience.

To extend and/or expand cellular coverage, additional low power base stations can be deployed and provide more robust wireless coverage to mobile devices. Low power base stations (commonly referred to as Home NodeBs or Home eNBs, collectively referred to as H(e)NBs, femto nodes, femtocell nodes, pico nodes, micro nodes, etc.) can be deployed for incremental capacity growth, richer user experience, in-building or other specific geographic coverage, and/or the like. In some implementations, femto cells may be installed in a user's home and provide indoor (as well as outdoor) wireless coverage to mobile units using existing broadband Internet connections.

However, an unplanned deployment of large numbers of HNBs can be challenging in several respects. For instance, when a mobile user or user equipment (UE) approaches a femto cell, a handover from a source femto cell or HNB to that particular femto cell (e.g., target HNB) may be initiated, but it may be difficult to uniquely identify the target femto cell to facilitate such a handover. The source HNB may not be able to detect all its neighboring HNBs via, e.g., a Neighboring Listen Module (NLM), thereby failing to read the information broadcast by the neighboring HNBs. Further, neighboring cells discovered by the UE through certain (e.g., pre-Release-9) reports may only contain a physical layer identifier (e.g., primary scrambling code) and not the unique base station identity of the target HNB cell. As such, handover failures may occur because the source HNB cannot handover to a potential target HNB with unknown identity.

Moreover, in a macro network, identification of MNBs is generally achieved by assigning a unique primary scrambling code (PSC) to a MNB in a certain coverage area. However, this is not feasible in femto cell deployments due to various factors including the limited number of PSCs that are allocated and reused, and the small scale coverage of HNBs compared to MNBs. More specifically, unplanned HNB deployment may result in fewer PSCs reserved for HNBs, and it becomes difficult for an operator or a Home NodeB Management System (HMS) to provide a reliable mapping between each PSC and respective base station identity. Therefore, using PSCs alone for HNB identification may result in ambiguities (e.g., PSC collision and PSC confusion) during an active handover procedure, and false HNB identification may lead to severe network performance degradation. As used in this application, PSC collision refers to when there is more than one cell with overlapping coverage area and with a same PSC value. In other words, PSC collision means two or more HNBs with the same PSC value. PSC confusion, on the other hand, occurs when there is more than one neighboring cell with the same PSC value and the serving cell does not know which one a UE is measuring and reporting.

Accordingly, it is desirable to develop a method and apparatus for facilitating reliable target base station identity discovery in wireless communications involving femto cells, and addressing PSC collision and PSC confusion problems.

### SUMMARY

Example embodiments of the invention are directed to systems and methods for facilitating reliable base station identity discovery in wireless communications involving femto cells.

In some embodiments, a method is provided for facilitating base station identity discovery in a wireless communications system. The method may comprise, for example, exchanging with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE.

In other embodiments, an apparatus is provided for facilitating base station identity discovery in a wireless communications system. The apparatus may comprise, for example, at least one processor and memory coupled to the at least one processor. The at least one processor may be configured to exchange with a UE a message including a U-RNTI of the UE, wherein the U-RNTI comprises an indicator representative of a base station identifier of an HNB associated with the UE.

In still other embodiments, another apparatus is provided for facilitating base station identity discovery in a wireless communications system. The apparatus may comprise, for example, means for exchanging with a UE a message including a U-RNTI of the UE, wherein the U-RNTI comprises an indicator representative of a base station identifier of an HNB associated with the UE. The apparatus may also comprise memory coupled to the means for exchanging.

In still other embodiments, a computer-readable medium is provided comprising code, which, when executed by a processor, causes the processor to perform operations for facilitating base station identity discovery in a wireless communications system. The computer-readable medium may comprise, for example, code for exchanging with a UE a message including a U-RNTI of the UE, wherein the U-RNTI comprises an indicator representative of a base station identifier of an HNB associated with the UE.

### BRIEF DESCRIPTION OF THE DRAWINGS

The accompanying drawings are presented to aid in the description of embodiments of the invention and are provided solely for illustration of the embodiments and not limitation thereof

FIG. 1 is a block diagram of an example wireless communication system that facilitates discovering and communicating cell identities between source and target HNBs.

FIG. 2 is a flow chart of an aspect of an example methodology for discovering and communicating cell identities between source and target HNBs.

FIG. 3 is a flow chart of an aspect of an example methodology for enabling a HNB to discover and obtain cell identities of neighboring cells.

FIG. 4 is a block diagram of an example wireless communication system in accordance with various aspects set forth herein.

FIG. 5 is an illustration of an example wireless network environment that can be employed in conjunction with the various systems and methods described herein.

FIG. 6 illustrates an example wireless communication system, configured to support a number of devices, in which the aspects herein can be implemented.

FIG. 7 is an illustration of an exemplary communication system to enable deployment of femtocells within a network environment.

FIG. 8 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As used in this application, the terms “component,” “module,” “system,” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal or device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device, or other processing devices connected to a wireless modem. Various aspects are also described herein in connection with a base station. A base station may be utilized for communicating with wireless terminal(s) and may also be referred to as an access point, a NodeB, evolved NodeB (eNB), home NodeB (HNB) or home evolved NodeB (HeNB), collectively referred to as H(e)NB, or some other terminology.

In general, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA, WiFi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

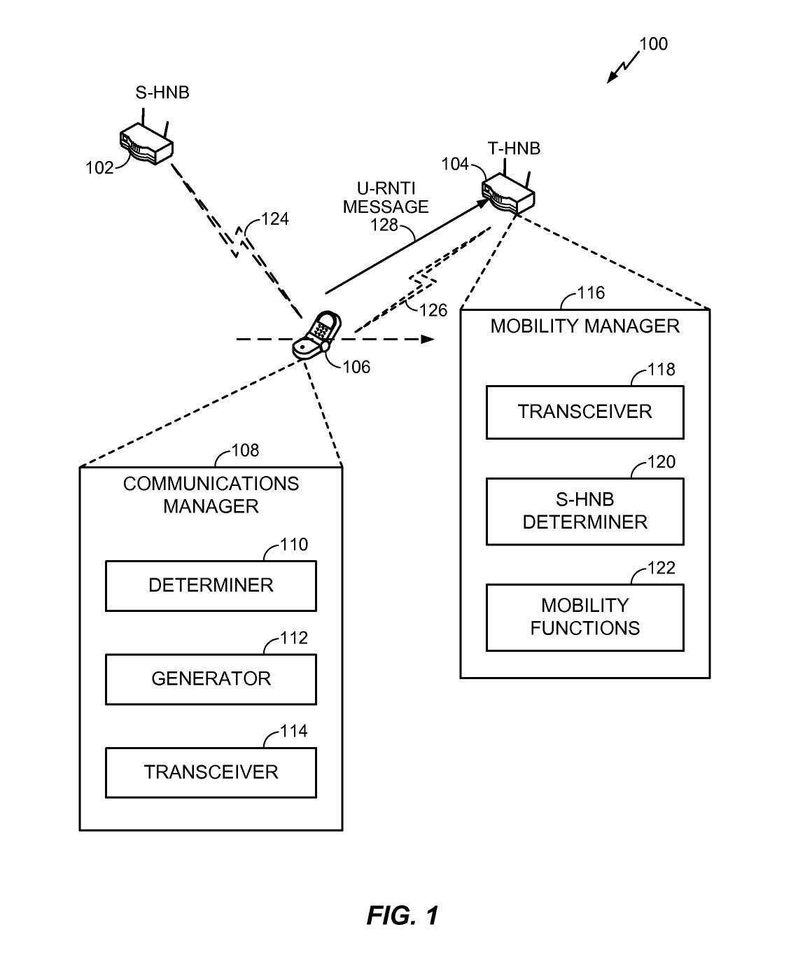

Referring to FIG. 1, an example wireless communication system 100 is illustrated for discovering cell identities involving at least one source HNB (S-HNB) 102, one target HNB (T-HNB) 104, and an HNB user (e.g., mobile station or UE 106), which may be any user in an open access HNB or an authorized subscriber in a closed access HNB. Wireless communication system 100 may also comprise a core network (CN) connected to one or more radio access networks (RANs) (not shown) which are often referred to as UTRAN networks (UMTS Terrestrial Radio Access Network). The RANs typically comprise a plurality of base stations (BS) controlled by at least one radio network controller (RNC) (not shown), and multiple RNCs may be connected to a mobile switching center (MSC) in the CN. As such, S-HNB 102 and T-HNB 104 may access a core network and connect to other networks, such as the Internet, via a backhaul connection to CN. Each of S-HNB 102 and T-HNB 104 has a working area defined by respective transmitting and receiving signal power, and is configured to provide active wireless communications and network access 124, 126 (e.g., voice, data, etc.) over, for example, a backhaul link with a network such as via a broadband internet connection.

In one aspect, two or more RNCs may be involved with the connections of a single UE during handovers. For example, provided that a UE initiates connections while being in a first cell of a first base station controlled by a first RNC, the UE subsequently executes a handover to a second cell of a second base station controlled by a second RNC. In such a case, the initial RNC is called the serving RNC (SRNC), and the second RNC is called the controlling RNC (CRNC). The second RNC is also often referred to as Drift RNC (DRNC). In the case of multi-diversity connections, e.g., connections in which a single radio connection is effected with cooperation of multiple simultaneous connections via multiple base stations, there may be more than one controlling RNCs, each controlling one or more of the sub-connections of the multi-diversity connection. The duties of a SRNC may be transferred to another RNC in order to optimize the connections within the wireless communication system 100. Such a process is referred to as a SRNC relocation.

It is noted that temporary identifiers called Radio Network Temporary

Identifiers (RNTI) are used as UE identifiers within a UTRAN and in signaling messages between the UE and the UTRAN. The RNTI identifiers are usually used and defined by the RNCs. Two types of RNTI are used in signaling messages between the UE and the UTRAN. One is used within and allocated by the SRNC and it is called the Serving RNC RNTI (s-RNTI). The other type is used within and allocated by a CRNC, when applicable, and it is referred to as the Controlling RNC RNTI (c-RNTI), or “Cell RNTI.”

An s-RNTI is uniquely allocated for all UEs having a Radio Resource Control (RRC) connection by the SRNC. An s-RNTI is usually re-allocated when the SRNC for the RRC connection is changed. In addition, each RNC has an identifier, called the RNC identifier (RNC-ID), and the RNC-ID in combination with s-RNTI form a unique UE identifier within the UTRAN. For this unique UE identifier, the term UTRAN-RNTI (U-RNTI) may be used. A c-RNTI may also be uniquely allocated for a UE by each CRNC through which the UE is able to communicate on a Dedicated Control Channel (DCCH). A c-RNTI is always allocated when a new UE context is created in a CRNC.

Typically, communication channels used for data transfer are grouped into two categories: common transport channels and dedicated transport channels. Common transport channels where UE identification is performed by using the RNTIs at least comprise the following channels: Random Access Channel (RACH), used for transmission of relatively small amount of data, e.g., signaling for initial access or non-real-time dedicated control or traffic data; Forward Access Channel (FACH): a downlink channel without closed-loop power control, and which is used for transmission of relatively small amounts of data, e.g., signaling (response) for initial access or non-real-time dedicated control or traffic data; and Paging Channel (PCH), a downlink channel used for broadcast of control information such as paging and notification information into an entire cell. The dedicated transport channel types at least comprise a Dedicated Channel (DCH), which is a channel dedicated to one UE, and which can be used for uplink or downlink data transmission.

As shown in FIG. 1, UE 106 may determine a need to perform a cell reselection from S-HNB 102 to T-HNB 104 while approaching T-HNB 104. Such a cell resection may occur when UE 106 is experiencing a handover failure between the source and target HNBs. Alternatively, such a cell resection may occur when UE 106 reselects to T-HNB 104 in Cell_FACH or Cell_PCH state. Subsequently, in accordance with the teachings and embodiments described herein, UE 106 generates a U-RNTI message 128 including an indicator representative of a base station identity of S-HNB 102. The U-RNTI message 128 can be transmitted to T-HNB 104 to allow T-HNB 104 to ascertain the identity of S-HNB 102, and to further allow T-HNB 104 to obtain additional information about S-HNB 102 or to otherwise reliably facilitate the cell reselection.

Upon receiving the U-RNTI message 128, T-HNB 104 is configured to determine the base station identity of S-HNB 102 based at least on the indicator, and perform a corresponding action in connection with the determined base station identity. For example, such an action may involve retrieving a UE context to enable mobility of the UE on common transport channels (e.g., FACH), or establishing a communication interface (e.g., an Iur-h interface) with S-HNB 102. Additionally, the action may include T-HNB 104 querying an HNB gateway (HNB-GW) to obtain more information on S-HNB 102. In this way, it will be appreciated that the U-RNTI message 128 herein is contemplated to allow T-HNB 104 to effectively figure out and/or address potential PSC collision and PSC confusion issues among S-HNB 102, T-HNB 104, and/or neighboring cells, which will be explained in more detail below.

Returning to FIG. 1, UE 106 can include a communications manager 108 for sharing cell identities among neighboring HNB cells. In some designs, upon detecting a handover failure due to the absence of target HNB base station identity information as discussed above, a determiner 110 detects and confirms a radio link failure (RLF) when the physical layer (L1) of UE 106 indicates “out of synch” in consecutive radio frames. In response, UE 106 may clear current dedicated physical channel configuration, and transition from connecting with S-HNB 102 in a Cell_DCH state into communicating with T-HNB 104 in a Cell_FACH state. A “Cell Update” message is generated by a generator 112 and transmitted along with a U-RNTI message 128 of UE 106 to T-HNB 104 by a transceiver 114. As mentioned briefly above and will be explained in more detail below, the U-RNTI message 128 is configured to include an indicator representative of a base station identity of the source HNB cell. In some aspects, the indicator may comprise a cell identifier of S-HNB 102, or a cell identifier and a primary scrambling code (PSC) of S-HNB 102, or a portion or a combination thereof It is to be appreciated that the transmitted U-RNTI message 128 can be used by T-HNB 104 to obtain information regarding the base station identity of S-HNB 102. In response to the “Cell Update” message, T-HNB 104 may issue an RRC connection release command, such that UE 106 can request to perform an RRC re-establishment with T-HNB 104.

In some designs, a direct Iur-h interface connectivity established between two HNBs may be employed, in which an HNB-GW may not be needed or involved in the Iur-h signaling. In other examples, Iur-h interface connectivity established between HNBs with the HNB-GW serving as an Iur-h proxy may be employed. An Iur-h interface may be established between the RNC and the HNB, and an Iur interface may be established between the RNC and the HNB-GW and between HNB-GWs.

Alternatively, certain aspects may be realized without requiring the establishment of an Iur-h interface. For example, while maintaining an active connection with S-HNB 102 in the Cell_FACH or Cell_PCH state, the determiner 110 of UE 106 may determine a need to perform a cell reselection to T-HNB 104. Accordingly, a “Cell Update” message is generated by the generator 112 and transmitted along with the U-RNTI message 128 from UE 106 to T-HNB 104 by the transceiver 114. The transmitted U-RNTI message 128 can be used by T-HNB 104 to obtain information regarding the base station identity of S-HNB 102. In response to the “Cell Update” message and cell reselection request, T-HNB 104 may issue an RRC connection release command, such that UE 106 can request to perform an RRC re-establishment with T-HNB 104.

Returning again to FIG. 1, T-HNB 104 includes a mobility manager 116 for obtaining a base station identity and/or PSC of S-HNB 102 based on the received U-RNTI message 128 through its transceiver 118. More specifically, an S-HNB determiner 120 extracts and determines the base station identity of S-HNB 102 based on the indicator included in the U-RNTI message 128. A mobility functions component 122 instructs T-HNB 104 to perform an action based on the determined base station identity of S-HNB 102. Example actions may include retrieving a UE context to enable mobility of the UE on common transport channels (e.g., FACH), establishing a communication interface (e.g., an Iur-h interface) with S-HNB 102, and querying an HNB-GW to obtain more information on S-HNB 102. It should be appreciated that S-HNB 102 can obtain the base station identity and the PSC of T-HNB 104 in a similar way according to various embodiments.

As mentioned above, additional actions triggered by the U-RNTI message 128 may allow T-HNB 104 to effectively figure out and/or address potential PSC collision and PSC confusion issues among S-HNB 102, T-HNB 104, and neighboring cells. For example, assuming that UE 106 moves from S-HNB 102 to T-HNB 104 and both have the same PSC (PSC collision), UE 106 would undergo a call failure and send “Cell Update” message to T-HNB 104 indicating the detected PSC collision. Such a collision may be resolved by allowing a change of the PSC of S-HNB 102, T-HNB 104, or both. In another example, when an HNB discovers at least one neighboring cell with a “Cell Update” message and comes to know of two different neighboring cells using the same PSC, PSC confusion is detected and may be resolved by communicating with one of the two different neighboring cells to change its PSC.

Further, after obtaining the base station identity of S-HNB 102, T-HNB 104 can also communicate its own identity to S-HNB 102 during active hand-in of UE 106. For example, T-HNB 104 may use SRNS relocation information (e.g., SRNS Relocation Info IE), which contains the U-RNTI message 128, or include its base station identity in the UE's Measurement Report message (MRM) or “UE History Information” IE.

As mentioned above, U-RNTIs are allocated by the SRNC to all UEs having an

RRC connection, and are valid in Cell_DCH, Cell_FACH, and Cell/URA_PCH states. Specifically, a U-RNTI is typically a 32-bit identifier which uniquely identifies the UE within the UTRAN, and needs to be re-allocated if the SRNC changes. General formats of the U-RNTI include: (i) u-RNTI (32-bits)=Serving RNC identity (12-bits)+s-RNTI (20-bits), (ii) u-RNTI (32-bits)=Extended Serving RNC identity (16-bits)+s-RNTI (16-bits), and the like. In general, the U-RNTI can be used by a UE to identify itself to the SRNC (e.g., in a “Cell Update” message), can be used by the SRNC to address the UE (e.g., paging), can be used by the DRNC to identify the UE to the SRNC, and so on. In some examples, the SRNC can indicate changes in the RNC to the UE via changes in its “U-RNTI” (e.g., via re-configuration messages).

To configure an indicator representative of base station identity information in connection with the U-RNTI, the following conditions may be taken into account.

As shown above, within the typical total of 32 bits of the U-RNTI, the SRNC identity may include 12 or 16 bits, and the S-RNTI accordingly may include 20 or 16 bits indicating a number of RRC connections under a particular HNB. It may be helpful to reserve a certain number of bits for S-RNTIs by assuming that up to 2^{x} RRC (i.e., DCH, FACH, PCH) connections may exist under the particular HNB, in which “x” represents the bits reserved for S-RNTIs. For example, for 64 (or 2⁶) RRC connections, 6 bits need to be reserved.

It is assumed that the remaining bits (i.e., 32−6=26 bits) are available, and can be used to indicate base station identity information of an HNB. Specifically, if the available bits (i.e., 32-x) are greater than or equal to the 28 bits which are typically used for base station identity of an HNB, it is expected that all 28 bits can be accommodated in the available U-RNTI bits. Alternatively, the available bits (i.e., 32-x) can be used to communicate the PSC and base station identity of an HNB. More specifically, source HNB PSC can be communicated to the target HNB. For 2^{y} possible HNB PSCs, “y” bits are needed. For example, for 32 (or 2⁵) possible HNB PSCs, at least 5 bits will be needed. The remaining available bits (i.e., 32-x-y) can be used to indicate the S-HNB base station identity. If the remaining available bits (i.e., 32-x-y) is less than 28 bits, they may be used to identify potential PSC collision and PSC confusion when the target HNB obtains the PSC of the source HNB. As mentioned above, when UE 106 moves from S-HNB 102 to T-HNB 104 and both have the same PSC (PSC collision), UE 106 would undergo a call failure and send a “Cell Update” message to T-HNB 104, indicating the detected PSC collision. In another example, when an HNB discovers at least one neighboring cell with a “Cell Update” message and comes to know of two different neighboring cells with the same PSC, PSC confusion is detected and may be resolved by communicating with one of the two different neighboring cells to change its PSC (e.g., T-HNB 104).

It should be appreciated that, since HNB-GW and associated HNBs may be assigned with the same RNC ID, HNB-GW may appear as a single RNC to the CN, for all HNBs associated with it (via, e.g., a concentrator function). For the sake of discussion herein, it is assumed that the 28-bit base station identity of each HNB/cell comprises a 12-bit RNC ID, which is a common deployment in macro networks and possible deployment for HNBs in 3GPP. That is, 12 bits of each HNB's base station identity may be a constant value, and depends on its attached GW. For more generic deployment, it may be helpful to assume that each HNB-GW (or HNB cluster) is assigned with a certain cell ID space. For example, for a 28-bit cell ID space, the 12 most significant bits (MSBs) may be constant.

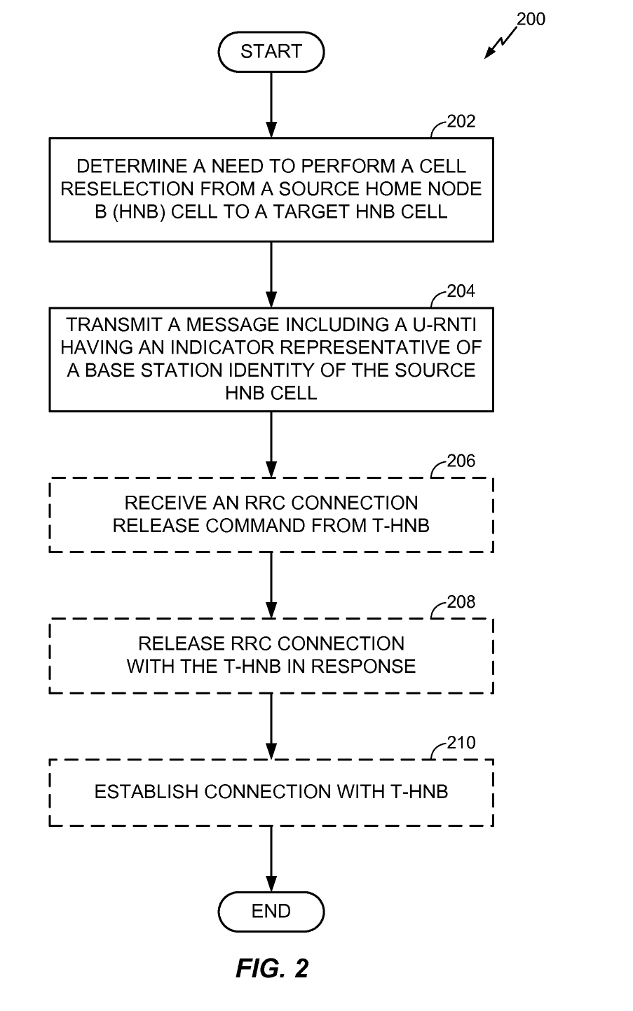

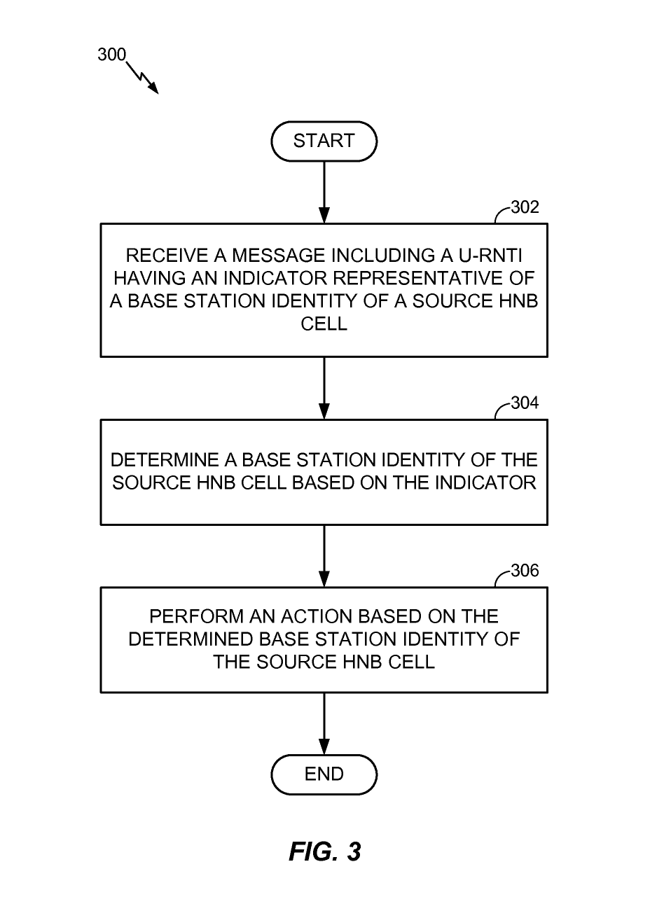

Referring to FIGS. 2-3, example methodologies relating to discovering cell identities in wireless communications are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 2, an example methodology 200 is illustrated that facilitates discovering and communicating cell identities between source and target HNBs. Methodology 200 may be defined, for example, in instructions stored on a UE, such as UE 106 of FIG. 1, or one or more components thereof, and executed by a processor to perform the described acts.

At 202, a determination may be made to perform a cell reselection from a source HNB to a candidate target HNB cell. For example, UE 106 may determine a need to perform a cell reselection from S-HNB 102 to T-HNB 104 while approaching T-HNB 104. In some examples, such a cell resection may be necessitated when UE 106 is experiencing a handover failure between the source and target HNBs. Subsequently, UE 106 generates a U-RNTI message including an indicator representative of a base station identity of S-HNB 102.

At 204, the generated U-RNTI message can be transmitted to T-HNB 104 to ascertain and exchange cell identities between the source and target HNBs for reliably facilitating the cell reselection.

In some examples, after transmitting the U-RNTI message, UE 106 may receive 206 an RRC connection release command issued by T-HNB 104. In response, UE 106 may release 208 a current RRC connection with T-HNB 104, and perform 210 an RRC re-establishment with T-HNB 104 at a later time.

Turning to FIG. 3, an example methodology 300 is illustrated that enables an HNB to discover and obtain cell identities of neighboring cells. Methodology 300 may be defined, for example, in instructions stored on an HNB, such as S-HNB 102 or T-HNB 104 of FIG. 1, or one or more components thereof, and executed by a processor to perform the described acts.

At 302, T-HNB 104 may be configured to receive from UE 106 a U-RNTI message including an indicator representative of a base station identity of a neighboring cell (e.g., S-HNB 102). In this regard, the S-HNB 102 may be a handover or previously camped source HNB and the T-HNB 104 may be a handover or reselection target HNB, as described above. At 304, T-HNB 104 is configured to determine the base station identity of S-HNB 102 based at least on the indicator, and perform at 306 a corresponding action in connection with the determined base station identity. Such an action may involve, for example, retrieving a UE context to enable mobility of the UE 106 in Cell_FACH, or establishing a communication interface (e.g., an Iur-h interface) with S-HNB 102. Additionally, T-HNB 104 may query an HNB gateway (HNB-GW) to obtain more information on S-HNB 102. As discussed above, the U-RNTI message accordingly provides the ability to effectively address potential PSC collision and PSC confusion issues among S-HNB 102, T-HNB 104, and neighboring cells.

Accordingly, it will be appreciated that a method for facilitating base station identity discovery in a wireless communications system may comprise exchanging (e.g., transmitting as in FIG. 2 or receiving as in FIG. 3) with a UE a message including a U-RNTI of the UE, with the U-RNTI comprising an indicator representative of a base station identity of an HNB associated with the UE. In this way, exchanging the message may comprise transmitting the message to the UE by the HNB, receiving the message at the UE from the HNB, or receiving the message at a second HNB from the UE, the first HNB being a handover source HNB and the second HNB being a handover target HNB.

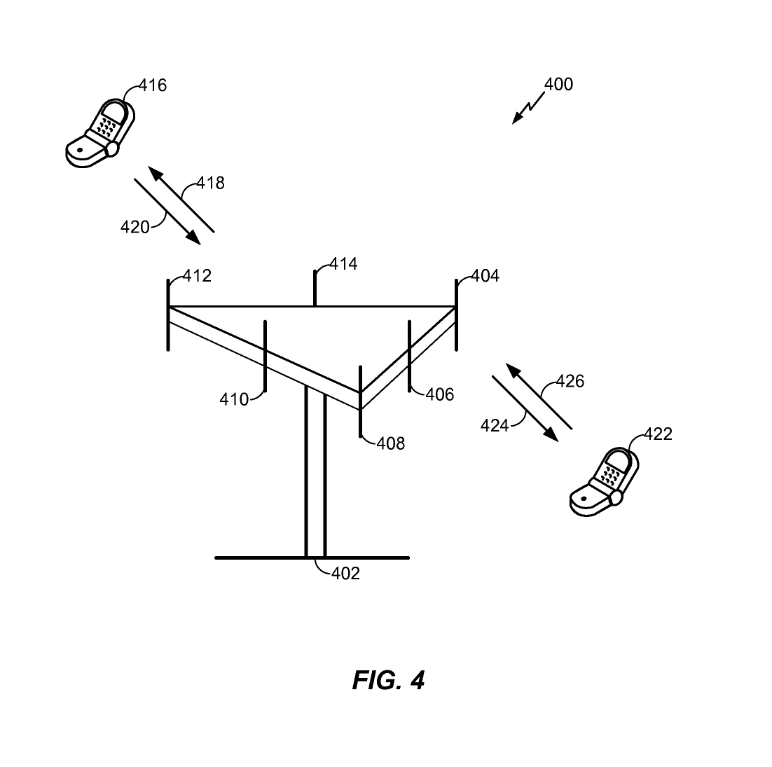

Referring now to FIG. 4, a wireless communication system 400 is illustrated in accordance with various embodiments presented herein. Wireless communication system 400 comprises a base station 402, such as S-HNB 102 and/or T-HNB 104 of FIG. 1, which can include multiple antenna groups. For example, one antenna group can include antennas 404 and 406, another group can comprise antennas 408 and 410, and an additional group can include antennas 412 and 414. Two antennas are illustrated for each antenna group; however, more or fewer antennas can be utilized for each group. Base station 402 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated.

Base station 402 can communicate with one or more mobile devices such as mobile device 416 and mobile device 422 (e.g., UE 106 of FIG. 1); however, it is to be appreciated that base station 402 can communicate with substantially any number of mobile devices similar to mobile devices 416 and 422. Mobile devices 416 and 422 can be, for example, cellular phones, smart phones, laptops, handheld communication devices, handheld computing devices, satellite radios, global positioning systems, PDAs, and/or any other suitable device for communicating over wireless communication system 400. As depicted, mobile device 416 is in communication with antennas 412 and 414, where antennas 412 and 414 transmit information to mobile device 416 over a forward link 418 and receive information from mobile device 416 over a reverse link 420. Moreover, mobile device 422 is in communication with antennas 404 and 406, where antennas 404 and 406 transmit information to mobile device 422 over a forward link 424 and receive information from mobile device 422 over a reverse link 426. In a frequency division duplex (FDD) system, forward link 418 can utilize a different frequency band than that used by reverse link 420, and forward link 424 can employ a different frequency band than that employed by reverse link 426, for example. Further, in a time division duplex (TDD) system, forward link 418 and reverse link 420 can utilize a common frequency band and forward link 424 and reverse link 426 can utilize a common frequency band.

Each group of antennas and/or the area in which they are designated to communicate can be referred to as a sector of base station 402. For example, antenna groups can be designed to communicate to mobile devices in a sector of the areas covered by base station 402. In communication over forward links 418 and 424, the transmitting antennas of base station 402 can utilize beamforming to improve signal-to-noise ratio of forward links 418 and 424 for mobile devices 416 and 422. Also, while base station 402 utilizes beamforming to transmit to mobile devices 416 and 422 scattered randomly through an associated coverage area, mobile devices in neighboring cells can be subject to less interference as compared to a base station transmitting through a single antenna to all its mobile devices. Moreover, mobile devices 416 and 422 can communicate directly with one another using a peer-to-peer or ad hoc technology as described. According to an example, wireless communication system 400 can be a multiple-input multiple-output (MIMO) communication system.

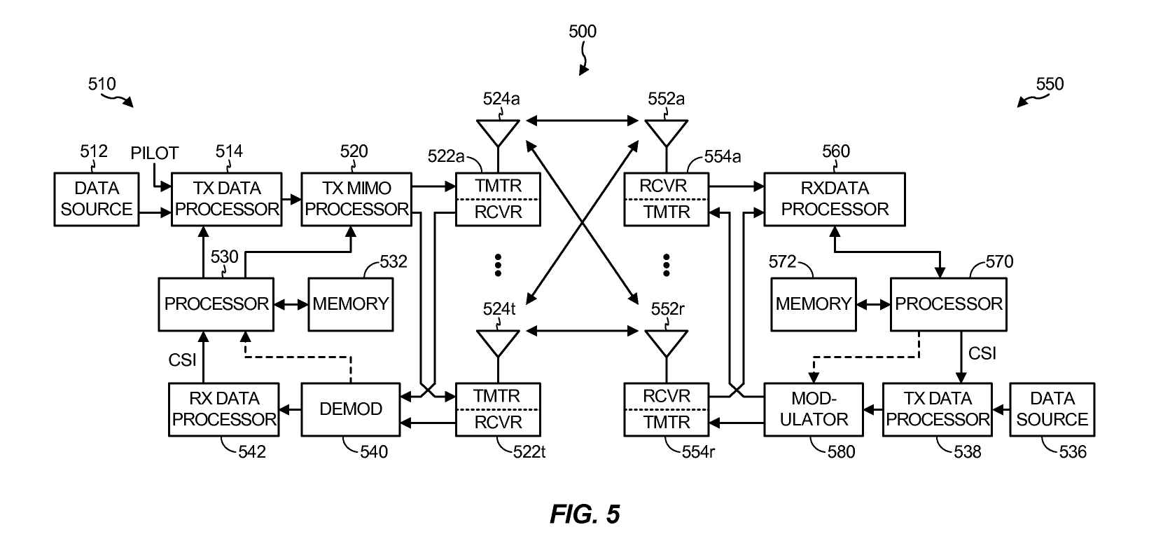

FIG. 5 shows an example wireless communication system 500. The wireless communication system 500 depicts one base station 510 such as S-HNB 102 and/or T-HNB 104 of FIG. 1, which can include a femto node, and one mobile device 550 (e.g., UE 106 of FIG. 1) for sake of brevity. However, it is to be appreciated that wireless communication system 500 can include more than one base station and/or more than one mobile device, wherein additional base stations and/or mobile devices can be substantially similar or different from example base station 510 and mobile device 550 described below. In addition, it is to be appreciated that base station 510 and/or mobile device 550 can employ the systems (FIG. 1) and/or methods (FIGS. 2-3) described herein to facilitate wireless communication therebetween. For example, components or functions of the systems and/or methods described herein can be part of a memory 532 and/or 572 or processors 530 and/or 570 described below, and/or can be executed by processors 530 and/or 570 to perform the disclosed functions.

At base station 510, traffic data for a number of data streams is provided from a data source 512 to a transmit (TX) data processor 514. According to an example, each data stream can be transmitted over a respective antenna. TX data processor 514 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 550 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 530.

The modulation symbols for the data streams can be provided to a TX MIMO processor 520, which can further process the modulation symbols (e.g., for OFDM). TX MIMO processor 520 then provides NT modulation symbol streams to NT transmitters (TMTR) 522a through 522t. In various embodiments, TX MIMO processor 520 applies beamforming weights to the symbols of the data streams and to the antenna from which the symbol is being transmitted.

Each transmitter 522a though 522t receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 522a through 522t are transmitted from NT antennas 524a through 524t, respectively.

At mobile device 550, the transmitted modulated signals are received by NR antennas 552a through 552r and the received signal from each antenna 552a through 552r is provided to a respective receiver (RCVR) 554a through 554r. Each receiver 554a through 554r conditions (e.g., filters, amplifies, and downconverts) a respective signal, digitizes the conditioned signal to provide samples, and further processes the samples to provide a corresponding “received” symbol stream.

An RX data processor 560 can receive and process the NR received symbol streams from the NR receivers 554a through 554r based on a particular receiver processing technique to provide NT “detected” symbol streams. RX data processor 560 can demodulate, deinterleave, and decode each detected symbol stream to recover the traffic data for the data stream. The processing by RX data processor 560 is complementary to that performed by TX MIMO processor 520 and TX data processor 514 at base station 510.

The reverse link message can comprise various types of information regarding the communication link and/or the received data stream. The reverse link message can be processed by a TX data processor 538, which also receives traffic data for a number of data streams from a data source 536, modulated by a modulator 580, conditioned by transmitters 554a through 554r, and transmitted back to base station 510.

At base station 510, the modulated signals from mobile device 550 are received by antennas 524, conditioned by receivers 522, demodulated by a demodulator 540, and processed by a RX data processor 542 to extract the reverse link message transmitted by mobile device 550. Further, processor 530 can process the extracted message to determine which precoding matrix to use for determining the beamforming weights.

Processors 530 and 570 can direct (e.g., control, coordinate, manage, etc.) operation at base station 510 and mobile device 550, respectively. Respective processors 530 and 570 can be associated with memory 532 and 572 that store program codes and data. Processors 530 and 570 can also perform functionalities described herein to support selecting a paging area identifier for one or more femto nodes.

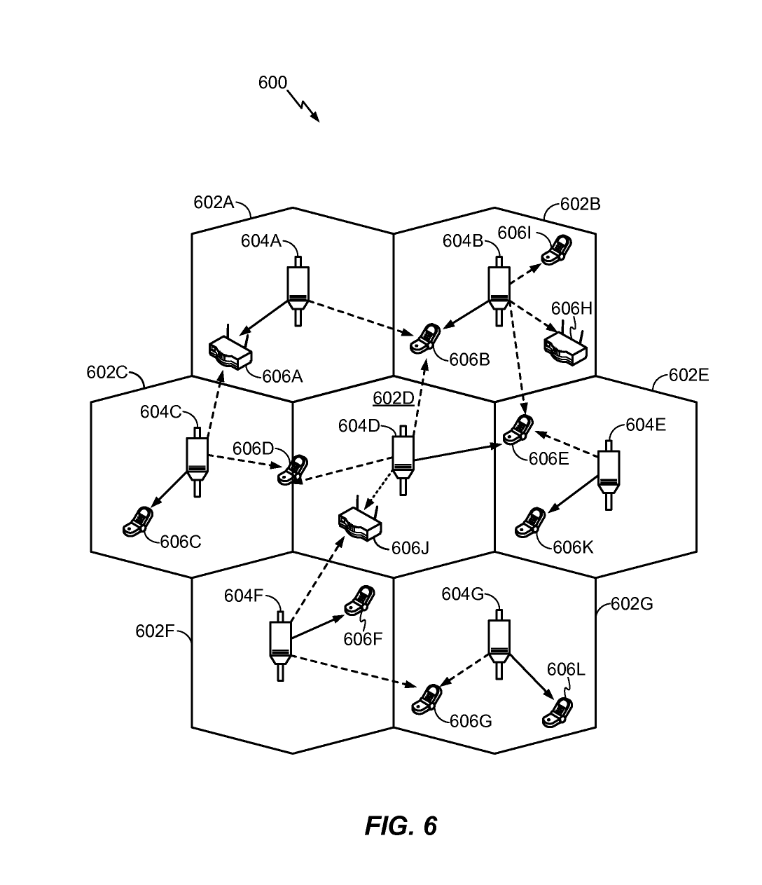

FIG. 6 illustrates a wireless communication system 600, configured to support a number of users, in which the teachings herein may be implemented. The wireless communication system 600 provides communication for multiple cells 602, such as, for example, macro cells 602A-602G, with each cell being serviced by a corresponding access node 604 (e.g., access nodes 604A-604G). As shown in FIG. 6, access terminals 606 (e.g., access terminals 606A-606L, such as UE 106 of FIG. 1) can be dispersed at various locations throughout the system over time. Each access terminal 606 can communicate with one or more access nodes 604 on a forward link (FL) and/or a reverse link (RL) at a given moment, depending upon whether the access terminal 606 is active and whether it is in soft handoff, for example. The wireless communication system 600 can provide service over a large geographic region.

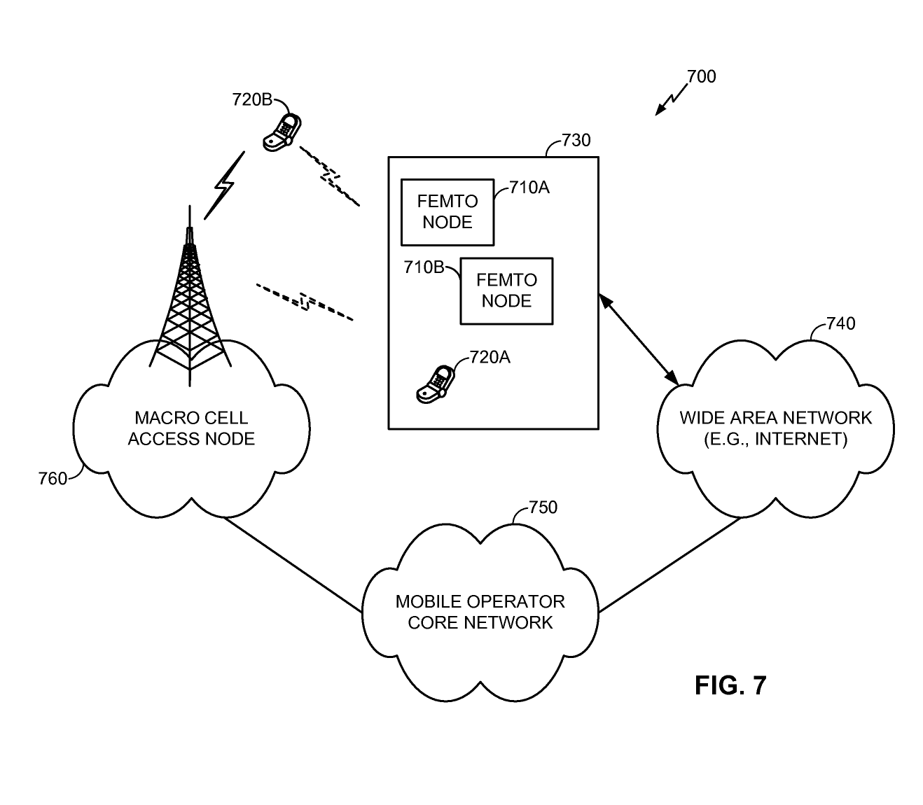

FIG. 7 illustrates an exemplary communication system 700 where one or more femto nodes are deployed within a network environment. Specifically, the communication system 700 includes multiple femto nodes 710A and 710B (e.g., femtocell nodes or H(e)NB, such as S-HNB 102 and/or T-HNB 104 of FIG. 1) installed in a relatively small scale network environment (e.g., in one or more user residences 730). Each femto node 710 can be coupled to a wide area network 740 (e.g., the Internet) and a mobile operator core network 750 via a digital subscriber line (DSL) router, a cable modem, a wireless link, or other connectivity means (not shown). As will be discussed below, each femto node 710 can be configured to serve associated access terminals 720 (e.g., access terminal 720A, such as UE 106 of FIG. 1) and, optionally, alien access terminals 720 (e.g., access terminal 720B). In other words, access to femto nodes 710 can be restricted such that a given access terminal 720 can be served by a set of designated (e.g., home) femto node(s) 710 but may not be served by any non-designated femto nodes 710 (e.g., a neighbor's femto node).

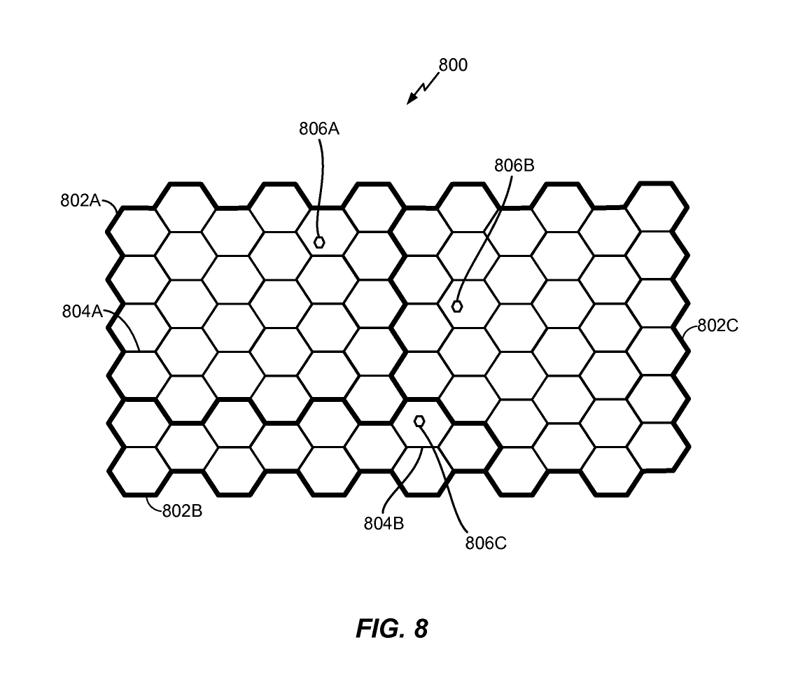

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 (e.g., 804A and 804B) are represented by the hexagons. The tracking areas 802 also include femto coverage areas 806 (e.g., 806A, 806B, and 806C), such as the working area of S-HNB 102 and/or T-HNB 104 of FIG. 1. In this example, each of the femto coverage areas 806 (e.g., femto coverage area 806C) is depicted within a macro coverage area 804 (e.g., macro coverage area 804B). It should be appreciated, however, that a femto coverage area 806 may not lie entirely within a macro coverage area 804. In practice, a large number of femto coverage areas 806 can be defined with a given tracking area 802 or macro coverage area 804. Also, one or more pico coverage areas (not shown) can be defined within a given tracking area 802 or macro coverage area 804.

Referring again to FIG. 7, the owner of a femto node 710 can subscribe to mobile service, such as, for example, 3G mobile service, offered through the mobile operator core network 750. In another example, the femto node 710 can be operated by the mobile operator core network 750 to expand coverage of the wireless network. In addition, an access terminal 720 can be capable of operating both in macro environments and in smaller scale (e.g., residential) network environments. Thus, for example, depending on the current location of the access terminal 720, the access terminal 720 can be served by a macro cell access node 760 or by any one of a set of femto nodes 710 (e.g., the femto nodes 710A and 710B that reside within a corresponding user residence 730). For example, when a subscriber is outside his home, he is served by a standard macro cell access node (e.g., macro cell access node 760) and when the subscriber is at home, he is served by a femto node (e.g., node 710A). Here, it should be appreciated that a femto node 710 can be backward compatible with existing access terminals 720.

A femto node 710 can be deployed on a single frequency or, in the alternative, on multiple frequencies. Depending on the particular configuration, the single frequency or one or more of the multiple frequencies can overlap with one or more frequencies used by a macro cell access node (e.g., macro cell access node 760). In some aspects, an access terminal 720 can be configured to connect to a preferred femto node (e.g., the home femto node of the access terminal 720) whenever such connectivity is possible. For example, whenever the access terminal 720 is within the user's residence 730, it can communicate with the home femto node 710.

In some aspects, if the access terminal 720 operates within the mobile operator core network 750 but is not residing on its most preferred network (e.g., as defined in a preferred roaming list), the access terminal 720 can continue to search for the most preferred network (e.g., femto node 710) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 720 can limit the search for specific band and channel. For example, the search for the most preferred system can be repeated periodically. Upon discovery of a preferred femto node, such as femto node 710, the access terminal 720 selects the femto node 710 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 710 that reside within the corresponding user residence 730). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that is authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal

In one or more aspects, the functions, methods, or algorithms described may be implemented in hardware, software, firmware, or any combination thereof If implemented in software, the functions may be stored or transmitted as one or more instructions or code on a computer-readable medium, which may be incorporated into a computer program product. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for facilitating base station identity discovery in a wireless communications system, comprising:
exchanging with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE.

2. The method of claim 1, wherein the indicator comprises at least a portion of a cell identifier (C-Id) of the HNB.

3. The method of claim 1, wherein the indicator comprises at least a portion of a primary scrambling code (PSC) of the HNB.

4. The method of claim 1, wherein exchanging the message comprises transmitting the message to the UE by the HNB.

5. The method of claim 1, wherein exchanging the message comprises receiving the message at the UE from the HNB.

6. The method of claim 1, wherein exchanging the message comprises receiving the message at a second HNB from the UE, the first HNB being a handover or previously camped source HNB and the second HNB being a handover or reselection target HNB.

7. The method of claim 6, further comprising:
determining, by the target HNB, a base station identity of the source HNB based on the indicator; and
performing an action based on the determined base station identity of the source HNB.

8. The method of claim 7, wherein the action comprises retrieving a UE context to enable mobility of the UE in a forward access channel state (Cell_FACH).

9. The method of claim 7, wherein the action comprises retrieving a UE context to enable mobility of the UE in a paging channel state (Cell/URA_PCH).

10. The method of claim 7, wherein the action comprises establishing a communication interface with the source HNB.

11. The method of claim 7, wherein the action comprises:
identifying a PSC collision between the source HNB and the target HNB; and
causing a change of the PSC of the source HNB or the target HNB to address the PSC collision.

12. The method of claim 7, wherein the action comprises:
identifying a PSC confusion between at least two neighboring HNBs having an identical PSC; and
communicating with at least one of the neighboring HNBs to cause a change in its PSC to address the PSC confusion.

13. An apparatus for facilitating base station identity discovery in a wireless communications system, comprising:
at least one processor configured to exchange with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE; and
memory coupled to the at least one processor.

14. The apparatus of claim 13, wherein the indicator comprises at least a portion of a cell identifier (C-Id) of the HNB.

15. The apparatus of claim 13, wherein the indicator comprises at least a portion of a primary scrambling code (PSC) of the HNB.

16. The apparatus of claim 13, wherein the at least one processor is configured to exchange the message by transmitting the message to the UE from the HNB.

17. The apparatus of claim 13, wherein the at least one processor is configured to exchange the message by receiving the message at the UE from the HNB.

18. The apparatus of claim 13, wherein the at least one processor is configured to exchange the message by receiving the message at a second HNB from the UE, the first HNB being a handover or previously camped source HNB and the second HNB being a handover or reselection target HNB.

19. The apparatus of claim 18, wherein the at least one processor is further configured to:
determine, at the target HNB, a base station identity of the source HNB based on the indicator; and
perform an action based on the determined base station identity of the source HNB.

20. The apparatus of claim 19, wherein the action comprises retrieving a UE context to enable mobility of the UE in a forward access channel state (Cell_FACH).

21. The apparatus of claim 19, wherein the action comprises retrieving a UE context to enable mobility of the UE in a paging channel state (Cell/URA_PCH).

22. The apparatus of claim 19 wherein the action comprises establishing a communication interface with the source HNB.

23. The apparatus of claim 19, wherein the action comprises:
identifying a PSC collision between the source HNB and the target HNB; and
causing a change of the PSC of the source HNB or the target HNB to address the PSC collision.

24. The apparatus of claim 19, wherein the action comprises:
identifying a PSC confusion between at least two neighboring HNBs having an identical PSC; and
communicating with at least one of the neighboring HNBs to cause a change in its PSC to address the PSC confusion.

25. An apparatus for facilitating base station identity discovery in a wireless communications system, comprising:
means for exchanging with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE; and
memory coupled to the means for exchanging.

26. The apparatus of claim 25, wherein the indicator comprises at least a portion of a cell identifier (C-Id) of the HNB.

27. The apparatus of claim 25, wherein the indicator comprises at least a portion of a primary scrambling code (PSC) of the HNB.

28. The apparatus of claim 25, wherein the means for exchanging the message comprises means for transmitting the message to the UE from the HNB.

29. The apparatus of claim 25, wherein the means for exchanging the message comprises means for receiving the message at the UE from the HNB.

30. The apparatus of claim 25, wherein the means for exchanging the message comprises means for receiving the message at a second HNB from the UE, the first HNB being a handover or previously camped source HNB and the second HNB being a handover or reselection target HNB.

31. The apparatus of claim 30, further comprising:
means for determining, by the target HNB, a base station identity of the source HNB based on the indicator; and
means for performing an action based on the determined base station identity of the source HNB.

32. The apparatus of claim 31, wherein the action comprises retrieving a UE context to enable mobility of the UE in a forward access channel state (Cell_FACH).

33. The apparatus of claim 31, wherein the action comprises retrieving a UE context to enable mobility of the UE in a paging channel state (Cell/URA_PCH).

34. The apparatus of claim 31, wherein the action comprises establishing a communication interface with the source HNB.

35. The apparatus of claim 31, wherein the action comprises:
identifying a PSC collision between the source HNB and the target HNB; and
causing a change of the PSC of the source HNB or the target HNB to address the PSC collision.

36. The apparatus of claim 31, wherein the action comprises:
identifying a PSC confusion between at least two neighboring HNBs having an identical PSC; and
communicating with at least one of the neighboring HNBs to cause a change in its PSC to address the PSC confusion.

37. A non-transitory computer-readable medium comprising code, which, when executed by a processor, causes the processor to perform operations for facilitating base station identity discovery in a wireless communications system, the non-transitory computer-readable medium comprising:
code for exchanging with a User Equipment (UE) a message including a Universal Terrestrial Radio Access Network Radio Network Temporary Identifier (U-RNTI) of the UE, wherein the U-RNTI comprises an indicator representative of a base station identifier of a Home NodeB (HNB) associated with the UE.

38. The non-transitory computer-readable medium of claim 37, wherein the indicator comprises at least a portion of a cell identifier (C-Id) of the HNB.

39. The non-transitory computer-readable medium of claim 37, wherein the indicator comprises at least a portion of a primary scrambling code (PSC) of the HNB.

40. The non-transitory computer-readable medium of claim 37, wherein the code for exchanging the message comprises code for transmitting the message to the UE by the HNB.

41. The non-transitory computer-readable medium of claim 37, wherein the code for exchanging the message comprises code for receiving the message at the UE from the HNB.

42. The non-transitory computer-readable medium of claim 37, wherein the code for exchanging the message comprises code for receiving the message at a second HNB from the UE, the first HNB being a handover or previously camped source HNB and the second HNB being a handover or reselection target HNB.

43. The non-transitory computer-readable medium of claim 42, further comprising:
code for determining, by the target HNB, a base station identity of the source HNB based on the indicator; and
code for performing an action based on the determined base station identity of the source HNB.

44. The non-transitory computer-readable medium of claim 43, wherein the action comprises retrieving a UE context to enable mobility of the UE in a forward access channel state (Cell_FACH).

45. The non-transitory computer-readable medium of claim 43, wherein the action comprises retrieving a UE context to enable mobility of the UE in a paging channel state (Cell/URA_PCH).

46. The non-transitory computer-readable medium of claim 43, wherein the action comprises establishing a communication interface with the source HNB.

47. The non-transitory computer-readable medium of claim 43, wherein the action comprises:
identifying a PSC collision between the source HNB and the target HNB; and
causing a change of the PSC of the source HNB or the target HNB to address the PSC collision.

48. The non-transitory computer-readable medium of claim 43, wherein the action comprises:
identifying a PSC confusion between at least two neighboring HNBs having an identical PSC; and
communicating with at least one of the neighboring HNBs to cause a change in its PSC to address the PSC confusion.
